(19) United States
(12) Patent Application Publication
(10) Pub. No.: US 2026/0153210 A1
(43) Pub. Date: Jun. 4, 2026

(54) VEHICLE LIGHT DEVICE CONFIGURED TO PERFORM A HIGH-MOUNT STOP LIGHT FUNCTION

(71) Applicant: VALEO VISION, Bobigny (FR)

(72) Inventors: Cedric GILLET, Bobigny (FR); Christophe VALOIS, Bobigny (FR); Richard GELOEN, Bobigny (FR); Alexandre FRANC, Bobigny (FR)

(73) Assignee: VALEO VISION, Bobigny (FR)

(21) Appl. No.: 19/112,627

(22) PCT Filed: Sep. 18, 2023
(86) PCT No.: PCT/EP2023/075657

§ 371 Date: Feb. 12, 2026

(30) Foreign Application Priority Data
Sep. 19, 2022 (FR) FR2209412

(51) Int. Cl. F21S 43/14; F21S 43/31

(52) U.S. Cl. CPC F21S 43/14; F21S 43/31

(57) ABSTRACT

The invention relates to a light device configured to perform a high-mount stop light function and includes a housing configured to receive optical modules, an optical module support fixed to the housing, a primary optical module configured to perform the high-mount stop light function, a secondary optical module configured to perform a function of projecting a light pattern onto a reflection surface, an output lens with a pattern and configured to close the housing. The primary optical module is a cylindrical light guide configured to cooperate with primary light rays generated by at least one primary light source, and the secondary optical module includes a first electronic support and at least one secondary light source configured to generate secondary light rays.

### TECHNICAL FIELD

The present invention relates to a luminous device for a vehicle, said device being configured to perform a high-mount stop light function. It is particularly applicable, but not limited, to automotive vehicles.

### BACKGROUND OF THE INVENTION

In the field of automotive vehicles, a luminous device for a vehicle, said device being configured to perform a high-mount stop light function and known to a person skilled in the art, comprises:
a housing configured to receive optical modules,
an optical module support fastened to said housing,
a primary optical module configured to perform the high-mount stop light function,
a secondary optical module configured to perform a function of projecting a luminous pattern onto a reflection surface,
an exit outer lens comprising a pattern.

The primary optical module comprises:
an electronic support,
a plurality of light sources (approximately eighteen) arranged on the electronic support and configured to emit light rays,
a plurality of reflectors on which the light rays from the light sources are reflected to form a primary light beam that exits toward the outside of the automotive vehicle.

The secondary optical module is configured to perform a function of projecting a luminous pattern onto an exit outer lens, said luminous pattern being reflected on a reflection surface. The secondary optical module comprises:
an electronic support,
a plurality of light sources (approximately fifty-four) arranged on the electronic support and configured to emit light rays to form a secondary light beam that passes through an exit outer lens to form said luminous pattern that is reflected on the reflection surface.

One drawback of this prior art is that the assembly formed by the housing, the optical module support, the primary optical module, and the secondary optical module, has a large footprint in the vertical dimension and is too deep.

In this context, the present invention aims to propose a luminous device for a vehicle, said device being configured to perform a high-mount stop light function that overcomes the aforementioned drawback.

### SUMMARY OF THE INVENTION

To this end, the invention proposes a luminous device for a vehicle, said device being configured to perform a high-mount stop light function and comprising:
a housing configured to receive optical modules,
an optical module support fastened to said housing,
a primary optical module configured to perform the high-mount stop light function,
a secondary optical module configured to perform a function of projecting a luminous pattern onto a reflection surface,
an exit outer lens comprising a pattern and configured to close said housing,
characterized in that:
said primary optical module is a cylindrical light guide configured to interact with primary light rays generated by at least one primary light source, and
said secondary optical module comprises a first electronic support and at least one secondary light source configured to generate secondary light rays.

As will be seen in detail below, replacing the reflectors by a cylindrical light guide thus makes it possible to considerably reduce the vertical footprint of the luminous device. In addition, the reduction of the number of primary light sources and of the surface area of their electronic support also makes it possible to reduce the depth of the luminous device.

According to non-limiting embodiments, said luminous device may further comprise one or more of the following additional features, taken alone or in any technically possible combination.

According to one non-limiting embodiment, said reflection surface is a rear window of said vehicle.

According to one non-limiting embodiment, said optical module support is configured to receive said primary optical module.

According to one non-limiting embodiment, said secondary optical module is assembled directly on the housing.

According to one non-limiting embodiment, said optical module support is configured to receive said primary optical module and said secondary optical module.

According to one non-limiting embodiment, said at least one primary light source and said at least one secondary light source may be activated independently of each other.

According to one non-limiting embodiment, said at least one primary light source is arranged on at least one second electronic support different from said first electronic support, or is arranged on said first electronic support.

According to one non-limiting embodiment, said exit outer lens comprises a first portion incorporating said pattern and a second portion arranged on either side of the first portion, configured to form a join with said housing.

According to one non-limiting embodiment, said housing comprises a cavity configured to receive a separating rib of the optical module support.

According to one non-limiting embodiment, said luminous device is a high-mount stop light.

According to one non-limiting embodiment, said luminous device comprises two primary light sources.

According to one non-limiting embodiment, said at least one primary light source and said at least one secondary light are semiconductor light sources.

According to one non-limiting embodiment, the first central portion of the exit outer lens is transparent.

According to one non-limiting embodiment, the first central portion of the exit outer lens is semi-transparent.

According to one non-limiting embodiment, the first central portion of the exit outer lens is diffusing.

According to one non-limiting embodiment, the second portion of said closing outer lens is opaque.

According to one non-limiting embodiment, said primary optical module comprises at least one end comprising a face opposite which a primary light source is arranged.

According to one non-limiting embodiment, said primary optical module comprises curved ends such that the faces of said ends are respectively situated opposite the primary light sources.

According to one non-limiting embodiment, the optical module support comprises a holder in which the primary optical module is housed, and comprises a separating rib extending in said housing.

According to one non-limiting embodiment, the optical module support comprises a holder in which the primary optical module is housed, a separating rib extending in said housing, and a flat portion configured to receive the first electronic support.

### BRIEF DESCRIPTION OF DRAWINGS

The invention and the various applications thereof will be better understood on reading the following description and on studying the accompanying figures, in which:

FIG. 1 illustrates a diagram of a luminous device for a vehicle, said device being configured to perform a high-mount stop light function, said luminous device comprising a housing, an optical support module, a primary optical module that is a cylindrical light guide, a secondary optical module comprising a first electronic support, and an exit outer lens, according to one non-limiting embodiment of the invention,

FIG. 2 illustrates a longitudinal schematic view of a rear spoiler of a vehicle, said rear spoiler comprising said luminous device in FIG. 1, according to one non-limiting embodiment,

FIG. 3 illustrates a schematic transverse cross-sectional view of the luminous device in FIG. 1, according to a first non-limiting embodiment,

FIG. 4 illustrates a schematic transverse cross-sectional view of the luminous device in FIG. 1, according to a second non-limiting embodiment,

FIG. 5 illustrates a top view of the housing of the luminous device in FIG. 1 with said cylindrical light guide and associated primary light sources, and said secondary optical module comprising secondary light sources, according to one non-limiting embodiment,

FIG. 6 illustrates a schematic view of the primary optical module in FIG. 1 with an arrangement of primary light sources according to a first non-limiting embodiment, and the first electronic support of the secondary optical module in FIG. 1 with secondary light sources, according to one non-limiting embodiment, and

FIG. 7 illustrates a schematic view of the primary optical module in FIG. 1 with an arrangement of primary light sources according to a second non-limiting embodiment, and the first electronic support of the secondary optical module in FIG. 1 with secondary light sources, according to one non-limiting embodiment.

### DETAILED DESCRIPTION OF THE INVENTION

Elements that are identical in terms of structure or function and that appear in different figures are denoted by the same reference signs, unless specified otherwise.

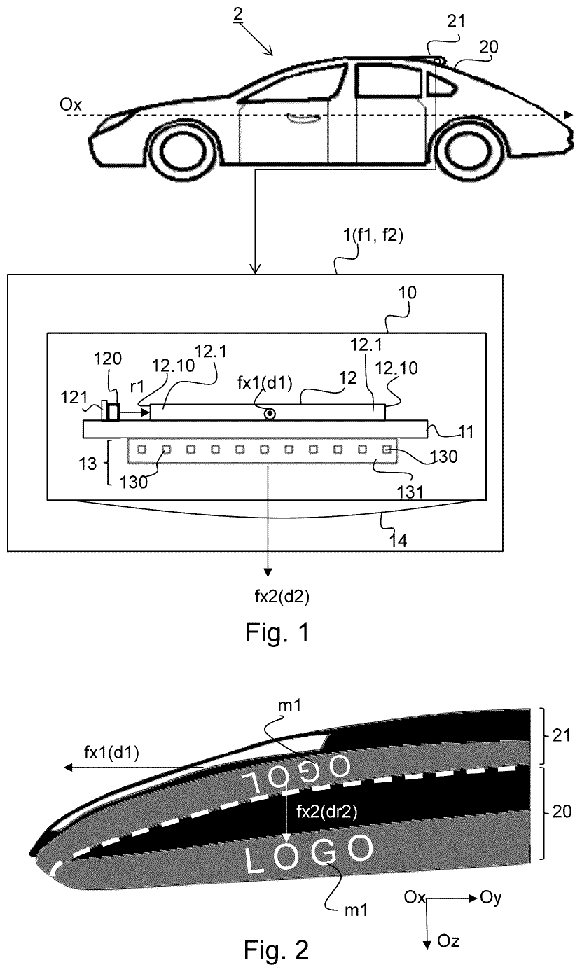

The luminous device 1 for a vehicle according to the invention is described with reference to FIGS. 1 to 7. In one non-limiting embodiment, the vehicle 2 is an automotive vehicle. The term automotive vehicle is given to mean any type of motorized vehicle. This embodiment is given as a non-limiting example in the remainder of the description. In the remainder of the description, the vehicle 2 is thus also referred to as the automotive vehicle 2. The vehicle axis Ox is shown in FIG. 1. The automotive vehicle 2 comprises said luminous device 1.

The luminous device 1 is configured to perform:
a high-mount stop light function f1 (called CHMSL “Center High Mounted Spot Light”), also known as a third stop light, and
a function f2 of projecting a luminous pattern m1 (illustrated in FIG. 2) onto a reflection surface 20 (illustrated in FIGS. 2 to 4) of said automotive vehicle 2. In one non-limiting embodiment, the reflection surface 20 is the rear window of said automotive vehicle 2, thus referred to as the rear window 20 in the remainder of the description.

Said luminous device 1 is thus a high-mount stop light that incorporates an additional function, function f2.

In one non-limiting embodiment, the luminous device 1 is arranged in a rear spoiler 21, also referred to as the spoiler 21 (illustrated in FIGS. 1 and 2) of the automotive vehicle 2, said spoiler being installed on the rear window 20 of the automotive vehicle 2. The spoiler 21 extends substantially perpendicularly to the vehicle axis Ox in a direction Oy. This non-limiting embodiment is given as a non-limiting example in the remainder of the description.

As illustrated in FIG. 1, the luminous device 1 comprises:
a housing 10,
an optical module support 11,
a primary optical module 12 configured to perform the high-mount stop light function f1,
a secondary optical module 13 configured to perform a function f2 of projecting a luminous pattern m1 onto the reflection surface 20,
an exit outer lens 14.

The luminous device 1 further comprises:
at least one primary light source 120, also referred to as the light source 120,
at least one secondary light source 130, also referred to as the light source 130.

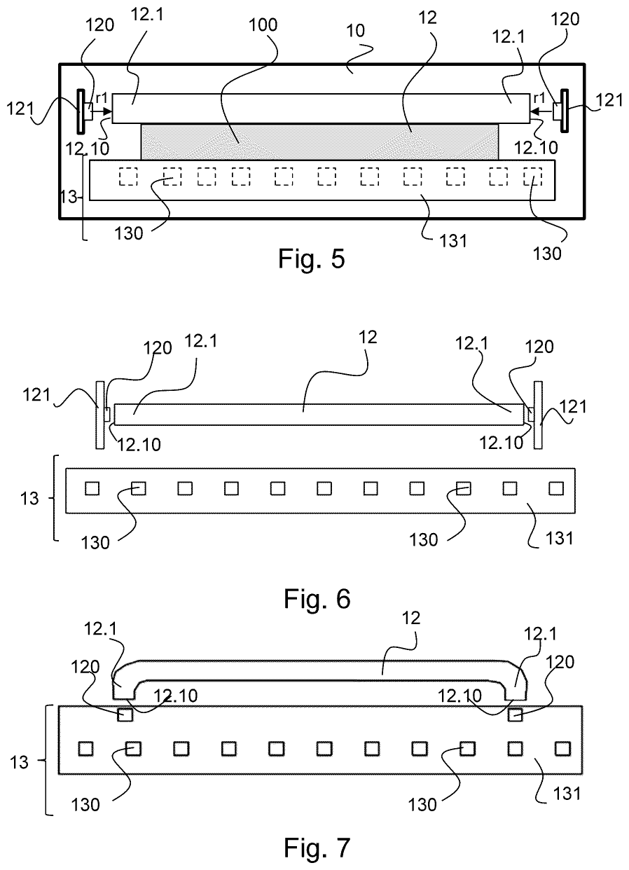

In one non-limiting embodiment illustrated in FIGS. 5 to 7, the luminous device 1 comprises two primary light sources 120. This non-limiting embodiment is given as a non-limiting example in the remainder of the description. In addition, in one non-limiting embodiment illustrated in FIG. 1, the luminous device 1 comprises more than two secondary light sources 130. In one non-limiting variant embodiment, it comprises between 20 and 60 secondary light sources 130. In one non-limiting example, it comprises 54 secondary light sources 130.

As illustrated in FIGS. 1 and 2, the housing 10 is configured to receive the primary optical module 12, the secondary optical module 13, the optical module support 11, the primary light sources 120, and the secondary light sources 130.

As illustrated in FIG. 5, the housing 10 comprises a cavity 100 configured to receive a separating rib 111 (described below) of the optical module support 11.

The optical module support 11, also referred to as the support 11, is fastened to the housing 10. In certain non-limiting embodiments, it is fastened to the housing 10 by screwing or snap-fitting.

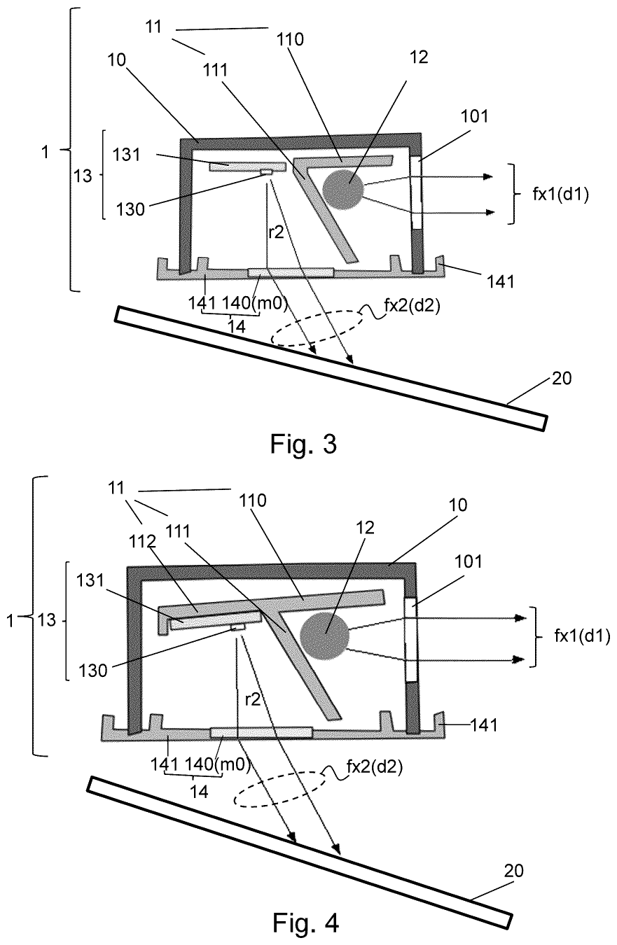

In a first non-limiting embodiment illustrated in FIG. 3, the support 11 is configured to receive the primary optical module 12 only. As illustrated in the cross-sectional view in FIG. 3, the support 11 comprises a holder 110 in which the primary optical module 12 is housed. The support 11 further comprises a separating rib 111 to separate the two functions f1 and f2, which continues on from the holder 110, extends substantially along the axis Oz perpendicular to the vehicle axis Ox, and is configured to be inserted into the cavity 100 of the housing 10. It makes it possible to hold the support 11 in the housing 10. In certain non-limiting embodiments, the primary optical module 12 is fastened to the support 11 by snap-fitting, screwing, or rivet heading. The holder 110 and the separating rib 111 further extend substantially longitudinally along the axis Oy when the luminous device 1 is installed in the spoiler 21. In the case of this first non-limiting embodiment, the second secondary module 13 is directly assembled on the housing 10, particularly a first electronic support 131 of said secondary optical module 13. In certain non-limiting examples, assembly is performed by screwing, bonding, stapling, snap-fitting, etc.

In a second non-limiting embodiment illustrated in FIG. 4, the support 11 is configured to receive the primary optical module 12 and the secondary optical module 13. As illustrated in the cross-sectional view in FIG. 4, the support 11 comprises the same holder 110 as in the first non-limiting embodiment, in which holder the primary optical module 12 is housed, and also the separating rib 111. The support 11 further comprises a flat portion 112 that extends along the holder 110 and is longitudinally contiguous to the holder 110 on one side. The separating rib 111 is then located between the holder 110 and this flat portion 112. The flat portion 112 is configured to receive the secondary optical module 13, particularly a first electronic support 131 of said secondary optical module 13. The first electronic support 131 of the secondary optical module 13 is in plane-on-plane contact with this flat portion 1 and is assembled on this flat portion 112. In certain non-limiting examples, assembly is performed by screwing, bonding, stapling, snap-fitting, etc. The holder 110, the separating rib 111 and the flat portion 112 extend substantially longitudinally along the axis Oy when the luminous device 1 is installed in the spoiler 21.

The primary optical module 12 is a cylindrical light guide as illustrated in the cross-sectional views in FIGS. 3 and 4, which illustrate a cross-section of the cylindrical light guide 12. The primary optical module 12 is also referred to as the primary cylindrical light guide 12. A cylindrical cross-section allows satisfactory distribution of the light rays r1 from the associated primary light source 120. The primary optical module 12 extends longitudinally in the housing 10 substantially along the axis Oy along the spoiler 21 of the automotive vehicle 2 when the luminous device 1 is installed in said spoiler 21. The primary optical module 12 interacts with the primary light sources 120. As illustrated in FIGS. 1 to 4, the primary optical module 12 together the primary light sources 120 is configured to generate a primary light beam fx1 toward the outside of the automotive vehicle 1 in a substantially horizontal first direction dl (i.e. substantially parallel to the vehicle axis Ox) in order to perform the high-mount stop light function f1. As illustrated in FIGS. 3 and 4, the housing 10 comprises a window 101 made from a transparent material, said window being configured to allow the primary light beam fx1 through. As illustrated in FIG. 1, the primary optical module 12 comprises at least one end 12.1 comprising a face 12.10 opposite which a primary light source 120 is arranged. In one non-limiting embodiment illustrated in FIGS. 5 to 7, it comprises two ends 12.1 with a face 12.10 opposite which a respective primary light source 120 is arranged.

The secondary optical module 13 comprises the first electronic support 131, also referred to as the PCBA (printed circuit board assembly). The secondary optical module 13 extends longitudinally in the housing 10 substantially along the axis Oy along the spoiler 21 of the automotive vehicle 2 when the luminous device 1 is installed in said spoiler 21. The secondary optical module 13 comprises the secondary light sources 130. As illustrated in FIGS. 1 to 4, the secondary optical module 13 is configured to generate a secondary light beam fx2 downward in a substantially vertical second direction d2 along an axis Oz (i.e. substantially perpendicular to the vehicle axis Ox) in order to perform the function f2 of projecting a luminous pattern m1. The secondary light beam f2 passes through the exit outer lens 14 comprising a pattern m0 (illustrated in FIGS. 3 and 4) so as to create the luminous pattern m1 (illustrated in FIG. 2) that is reflected on the rear window 20 of the automotive vehicle 2. The reflection surface 20, here the rear window, makes it possible to create a holographic projection visible from the outside of the automotive vehicle 2 but not from the inside of the automotive vehicle 2. The holographic projection on the rear window 20 thus does not cause any inconvenience for the driver. For reasons of clarity in FIGS. 3 and 4, only one secondary light source 130 is shown.

In one non-limiting embodiment, the light sources 120 and 130 are semiconductor light sources. In one non-limiting embodiment, the semiconductor light sources form part of a light-emitting diode or a laser diode. The term light-emitting diode is given to mean any type of light-emitting diode, whether, by way of non-limiting example, these are LEDs (light-emitting diodes), OLEDs (organic LEDs), AMOLEDs (active-matrix organic LEDs), or FOLEDs (flexible OLEDs).

In a first non-limiting embodiment, said at least one primary light source 120 is arranged on at least a second electronic support 121 different from the first electronic support 131. As illustrated in FIG. 6, if there are two primary light sources 120 associated with the primary light guide 12, the two primary light sources 120 are arranged respectively on two second electronic supports 121 different from the first electronic support 131. Each second electronic support 121 is arranged opposite each face 12.10 of each end 12.1 of the cylindrical light guide 12. The two primary light sources 120 are thus distributed on either side of the cylindrical light guide 12. This first embodiment is easy to implement.

In a second non-limiting embodiment, said at least one primary light source 120 is arranged on the first electronic support 131. The second electronic support(s) 121 has/have thus been removed. As illustrated in FIG. 7, if there are two primary light sources 120 associated with the primary light guide 12, the two primary light sources 120 are arranged on the first electronic support 131 on which the secondary light sources 130 are arranged. In this case, the primary optical module 120 comprises curved ends 12.1 such that the faces 12.10 of these ends 12.1 are respectively situated opposite the primary light sources 120.

In one non-limiting embodiment, the primary light sources 120 and the secondary light sources 130 may be activated independently of each other. This makes it possible to control the high-mount stop light function f1 and the function f2 of projecting a luminous pattern m1 independently of each other.

In one non-limiting embodiment, the primary light sources 120 have a power greater than or equal to 30 lumens. In one non-limiting embodiment, the secondary light sources 130 have a power substantially equal to 9 lumens. It will be noted that the distribution of the secondary light sources 130 on the first electronic support 131 and their low power result in satisfactory thermal behavior. The heat emitted by the secondary light sources 130 is easily dissipated.

As illustrated in FIGS. 3 and 4, the primary light sources 120 emit primary light rays r1 (illustrated in FIG. 1 and FIG. 5), also referred to as light rays r1, which pass through the primary light guide 12 so as to generate the primary light beam fx1 (illustrated in FIGS. 1 to 4) that performs the high-mount stop light function.

As illustrated in FIGS. 3 and 4, the secondary light sources 130 emit secondary light rays r2, also referred to as light rays r2, and form the secondary light beam fx2 (illustrated on FIGS. 1 to 4) that performs the function f2 of projecting the luminous pattern m1.

As illustrated in FIGS. 3 and 4, the exit outer lens 14 is configured to close the housing 10. It comprises:
a first central portion 140 incorporating said pattern m0, also referred to as the window 140,
a second portion 141 arranged on either side of the central portion 140, which serves as a mask.

The first central portion 140 of the exit outer lens 14 is transparent, that is, it allows light through, or is diffusing (it makes it possible to diffuse the light rays r2). As illustrated in FIGS. 3 and 4, the secondary light beam fx2 passes through the central portion 140 so as to create a luminous pattern m1 as illustrated in FIG. 2. The luminous pattern m1 is thus visible through this central portion 140 but also due to the reflection thereof downward along the axis Oz on the reflection surface 20, here the rear window 20 of the automotive vehicle. There is thus a duplicated effect of the luminous pattern m1. A so-called holographic luminous logo m1 is thus obtained. In one non-limiting embodiment, the pattern m0 is a manufacturer's logo. It will be noted that in order to have a luminous logo m1 the right way up on the rear window 20, the outline of the logo m0 is inverted on the central portion 140 of the exit outer lens 14. FIG. 2 illustrates the inverted luminous logo m1 that results from the logo m0 (not visible in FIG. 2) through which the secondary light beam fx2 has passed, and the luminous logo m1 the right way up resulting from the reflection of the luminous logo m1 on the rear window 20. The secondary light sources 130 thus illuminate the inverted logo m0. The second portion 141 of the exit outer lens 14 is configured to form the connection, also referred to as the join, between the exit outer lens 14 and the housing 10.

In one non-limiting embodiment, the second portion 141 of the exit outer lens 14 is made from PC (polycarbonate). The PC provides a robust outer face, which does not break unlike polymethyl methacrylate (PMMA). In another non-limiting embodiment, the second portion 141 of the exit outer lens 14 is made from PMMA. In certain non-limiting embodiments, the first portion 140 is made from ABS (acrylonitrile butadiene styrene), vinyl, PET (polyethylene terephthalate), PMMA, or PC.

The pattern m0 of the exit outer lens 14 is produced according to various non-limiting embodiments set out below.

In a first non-limiting embodiment, the pattern m0 is formed by bi-injection molding. The exit outer lens 14 is thus bi-injection molded. This makes it possible to create the central portion 140 with the pattern m0 and the second portion 141.

In a second non-limiting embodiment, the pattern m0 is formed by means of a screen-printed or printed film. The exit outer lens 14 comprises a window on which the screen-printed or printed film is assembled (that is, placed and bonded). In certain non-limiting embodiments, the film is made from ABS (acrylonitrile butadiene styrene), vinyl, PET (polyethylene terephthalate), PMMA, or PC. In a first non-limiting variant embodiment, the exit outer lens 14 is completely transparent. In a second non-limiting variant embodiment, the exit outer lens 14 is bi-material, with a first transparent portion 140 and a second opaque portion 141. This makes it possible to manage light leakages at the join with the housing 10, the join between the exit outer lens 14 and the housing 10 being formed via the opaque portion 141.

In a third non-limiting embodiment, the pattern m0 is formed by a film overmolded in the exit outer lens 14. No assembly is required. In a first non-limiting variant embodiment, the exit outer lens 14 is completely transparent. In a second non-limiting variant embodiment, the exit outer lens 14 is bi-material, with a first transparent portion 140 and a second opaque portion 141. In certain non-limiting embodiments, the film is made from ABS (acrylonitrile butadiene styrene), vinyl, PET (polyethylene terephthalate), PMMA, or PC.

In a first non-limiting variant embodiment, the film is overmolded by means of an IML (in-mold labeling) process. It will be recalled that the IML process comprises the steps of forming and cutting a screen-printed film, and placing it in a mold into which a resin is injected. Since the IML process is known to those skilled in the art, it will not be described in more detail here.

In a second non-limiting variant embodiment, the film is overmolded by means of an IMD (in-mold decoration) process. It will be recalled that the IMD process comprises the steps of laying out a screen-printed film in a mold, forming it, and injecting a resin into the mold. Since the IMD process is known to those skilled in the art, it will not be described in more detail here.

In a fourth non-limiting embodiment, the pattern m0 is formed by a laser screen-printing process. In a first non-limiting variant embodiment, the screen-printing process is laser ablation. An opaque paint is applied to the exit outer lens 14, and the pattern m0 is then ablated using a laser. In one non-limiting variant embodiment, the exit outer lens 14 is transparent. In a second non-limiting variant embodiment, the screen-printing process is laser etching. An opaque paint is applied to a transparent or translucent film. The film is applied to the exit outer lens 14. The pattern m0 is then etched onto the film using a laser.

In a fifth non-limiting embodiment, the pattern m0 is formed by a hot stamping process. A template is mounted and heated on the exit outer lens 14. A plastic film with a hot-melt layer and opaque ink is inserted between the template and the exit outer lens 14, the template exerting pressure on the film. When the template heats up, the opaque ink is transferred onto protrusions of the exit outer lens 14, which forms a relief of the pattern m0.

In a sixth non-limiting embodiment, the pattern m0 is formed by a tampo-print process. A pad that comprises the pattern m0 in relief is dipped into ink and applied to the exit outer lens 14, exerting pressure on it. The pattern m0 is thus transferred onto the exit outer lens 14.

Of course, the description of the invention is not limited to the embodiments described above and to the field described above. In another non-limiting embodiment, a single primary light source 120 thus interacts with the primary optical module 12. In another non-limiting embodiment, the first central portion 140 of the exit outer lens 14 is thus semi-transparent.

The invention described thus has the following advantages in particular:
it makes it possible to incorporate the high-mount stop light function f1 and the projection function f2 into a single luminous device 1 while reducing the vertical footprint of the luminous device 1 by removing the reflectors of the prior art and replacing them with a cylindrical light guide,
it makes it possible to comply with the height defined for a rear high-mount stop light for any type of vehicle 2,
it thus makes it possible to adapt to steeply inclined rear windows and rear windows with smaller dimensions than for conventional vehicles, such as in the case of two-door automotive vehicles; the luminous device 1 is thus easy to incorporate into this type of rear window,
it makes it possible to considerably reduce the number of primary light sources 120. The surface area of said at least one second electronic support 121 (when it is different from the first electronic support 131) on which the primary light sources 120 rest is thus reduced, which also makes it possible to reduce the depth of the luminous device 1.

What is claimed is:

1. A luminous device configured to perform a high-mount stop light function and comprising:
a housing configured to receive optical modules,
an optical module support fastened to the housing,
a primary optical module configured to perform the high-mount stop light function,
a secondary optical module configured to perform a function of projecting a luminous pattern onto a reflection surface,
an exit outer lens including a pattern and configured to close the housing, wherein
the primary optical module is a cylindrical light guide configured to interact with primary light rays generated by at least one primary light source, and
the secondary optical module includes a first electronic support and at least one secondary light source configured to generate secondary light rays.

2. The luminous device as claimed in claim 1, wherein the reflection surface is a rear window of the vehicle.

3. The luminous device as claimed in claim 1, wherein the optical module support is configured to receive the primary optical module.

4. The luminous device as claimed in claim 3 wherein the secondary optical module is assembled directly on the housing.

5. The luminous device as claimed in claim 1, wherein the optical module support is configured to receive the primary optical module and the secondary optical module.

6. The luminous device as claimed in claim 1, wherein the at least one primary light source and the at least one secondary light source may be activated independently of each other.

7. The luminous device as claimed in claim 1, wherein the at least one primary light source is arranged on at least one second electronic support different from the first electronic support, or is arranged on the first electronic support.

8. The luminous device as claimed in claim 1, wherein the exit outer lens includes a first portion incorporating the pattern and a second portion arranged on either side of the first portion, configured to form a join with the housing.

9. The luminous device as claimed in claim 8, wherein the housing includes a cavity configured to receive a separating rib of the optical module support.

10. The luminous device as claimed in claim 1, wherein the luminous device is a high-mount stop light.
